(19) United States
(12) Patent Application Publication
(10) Pub. No.: US 2001/0009580 A1
(43) Pub. Date: Jul. 26, 2001

(54) Information encryption device and encryption method

(76) Inventor: Takashi Ikeda, Niigata (JP)

Correspondence Address: SUGHRUE, MION, ZINN, MACPEAK & SEAS, 2100 Pennsylvania Ave, N.W., Washington, DC, 20037-3202, US

(21) Appl. No.: 09/768,154

(22) Filed: Jan. 24, 2001

(30) Foreign Application Priority Data
Jan. 26, 2000 (JP) 2000-021810

(51) Int. Cl. H04N 7/167; H04L 9/18

(52) U.S. Cl. 380/201; 380/200; 705/51; 705/57

(57) ABSTRACT

An information processor that receives information that is distributed from an external information source and that stores and uses said distributed information comprises a unique information storage means, an encryption means, and a decoding means. The unique information storage means stores unique information that is not duplicated in devices other than a predesignated information processor. The encryption means encrypts the received distributed information using the unique information as an encryption key. The decoding means decodes data that have been encrypted by the encryption means with unique information that corresponds to the encryption key as the decoding key. The unique information storage means can be constituted as a read-only storage medium that permits only reading of the unique information that has been stored. The encryption key and the decoding key may be identical. The information processor is further provided with a storage device for storing data that have been encrypted. The storage medium that is installed in the storage device may be a storage medium such as a hard disk that cannot be removed, or may be an interchangeable or removable storage medium such as magnetic tape or an optical disk.

### BACKGROUND OF THE INVENTION

1. Field of the Invention

The present invention relates to an information encryption device and encryption method for encrypting copied information using an information processor such as a personal computer, and more particularly to an information encryption device and encryption method that limits the devices that can use the copied information to the information processor that executed the copying process.

2. Description of the Related Art

A recent increase in storage capacity of hard disks (HD) and the development of storage media having relatively large-capacity storage such as writable DVD-RAM (Digital Video Disk-Random Access Memory) and CD-R (Compact Disk-Recordable) have enabled the storage of long-playing voice information and image information into storage media by way of personal computers. Movies are representative of the long-playing information.

However, since such image information or voice information is copyrighted, the recording media used for recording this information have been limited to read-only CD-ROM and DVD in order to prevent copying.

As a result, the information recorded on these recording media can only be reproduced and used on relatively large-scale information processors provided beforehand with CD-ROM and DVD reproduction functionality. While information processors that stress portability have become popular in recent years, such processors rarely come provided with a CD-ROM or DVD reproduction functionality. These information processors therefore must be externally provided with a playback device as an expansion feature. This addition, however, detracts from the portability of the information processors.

To solve this problem, methods have been considered in which the image information or voice information to be used is stored into a storage medium such as the HD that is incorporated in the information processor. If the storage of data to a storage medium is not restricted, however, this method facilitates copying image information or voice information, and therefore has the problem of encouraging the violation of copyrights as mentioned hereinabove.

Furthermore, use of storage media such as the above-described HD complicates the discovery and control of illegal copying. One means of preventing the problem of infringement of copyright that may occur when copyrighted data are stored to a storage medium such as an HD involves restricting the range of possible use of a product that has been obtained by copying object data. Frequently employed methods of effecting this control involve, for example, requiring the input of a prescribed code before information can be read.

However, the key data for encryption when encrypting data by means of the prior art is determined according to the user's own wishes, and the protection of a copyright therefore depends only on the user's conscience. Thus, an information encryption method of the prior art is not constituted so as to prevent infringement of a copyright independent of the user.

As one example of this type of prior art technique, Japanese Patent Laid-open No. 131757/88 discloses a voice mail device. This voice mail device is constituted so as to encrypt voice information by means of an externally connected encryption device using an encryption keyword that is open to the user and then to store to an external storage device.

This device is constituted such that, when using data (voice information) that have been encrypted by means of the encryption device as described above, the user enters an already known decryption keyword from an input means, and the data are decoded in a decryption device using this decryption keyword.

Japanese Patent Laid-open No. 321749/97 discloses an encrypting means that is applied to an online security control system. In this encrypting means, data that are transmitted and received in communication between a host computer and terminal device are encrypted based on user ID. Key data that are used in this encryption can of course be determined by the user, and the transmission/reception data therefore can be used by entering this user's ID from any terminal.

Japanese Patent Laid-open No. 270191/89 discloses an encrypting means applied to a memory card. This encrypting means is provided in the input/output stage of a memory IC, and encrypts data written to the memory IC using key data. This publication does not disclose the type of data employed in encrypting and decrypting as the key data. Moreover, the encrypting means is not constituted for the purpose of encrypting copied data.

In contrast to the above-described encryption method that allows a user to determine the encryption key, a technique of the prior art in which the encryption key is determined by a prescribed random number generation method is described in the following publication.

Japanese Patent Laid-open No. 191079/99 discloses a semiconductor integrated circuit. In this semiconductor integrated circuit, when fabricating a Read-Only Memory (ROM), data are written into the ROM by a photomask, wherein the photomask is prepared based on the data that have already been encrypted. When decoding the written data, a decryption means is provided in the data output section, and in this decryption means, the data of the ROM are decoded using a decoding key code that has been entered by the user by way of an input means or using a decoding key code that has been held in another storage media. Thus, copying of data that have been stored in this ROM can be prevented in this semiconductor integrated circuit because data that have already been encrypted have been written into the ROM.

Finally, Japanese Patent Laid-open No. 234261/99 discloses an encrypting/decoding means that is applied to an integrated circuit. This encrypting/decoding means prevents a third party from deciphering encrypted data by using the encrypting key data and program data as a parameter that characterizes encrypting functions. Furthermore, since programmable logic gates for performing encryption and decoding of data are provided in an integrated circuit in this encrypting/decoding means, the method of encrypting/decoding cannot be detected from the outside. This encrypting/decoding means therefore prevents copying of the data that are stored in the semiconductor circuit, similar to the previously described semiconductor integrated circuit.

However, the above-described methods that use random numbers to determine the encrypting key are techniques directed to storing the encrypted data in storage media such as ROM that are typically non-rewritable. Thus, although they permit the storage of information distributed from an external information source as described hereinabove, they do not go so far as to solve the problem of restricting the use of this stored information to prevent violation of copyright.

Thus, although the encrypting and decoding methods of the prior art can maintain the secrecy of data from a third party other than the user or prevent copying of the data itself, they are not intended to permit copying of information (such as image information or voice information) while preventing the copy from becoming an infringement of copyright.

### SUMMARY OF THE INVENTION

The present invention has been made in view of these problems, and is intended to provide an information encryption device and encryption method that, while allowing copyrighted information such as image information and voice information to be copied, are capable of precluding the possibility of copyright violation through the use of the copied information.

To achieve the above-described object, the information encryption device of the present invention comprises:

a unique information storage means for storing unique information that is not duplicated in devices other than a predesignated information processor or that is specific to a predesignated information processor;

an encryption means for encrypting received distributed information with the unique information as an encryption key; and

a decoding means for decoding data that have been encrypted by the encryption means with unique information that corresponds to the encryption key as a decoding key.

The encryption key and the decoding key may be identical.

The unique information storage means may be a read-only storage medium that permits only reading of said unique information that has been stored.

The information encryption device of the present invention further comprises a storage means for storing data that have been encrypted by the encryption means.

The storage means may be constituted such that a storage medium to which encrypted data are written is inexchangeably fixed to the information encryption device.

The storage means may be constituted such that the storage medium to which the encrypted data are written is exchangeably installed in the information encryption devicer.

The information encryption device may further include a network interface means for taking in distributed information.

In addition, the unique information storage means may include unique information that is stored before the information encryption device reaches a user.

Furthermore, the unique information storage means may be constituted by a register.

The unique information may be a serial number that is assigned to that information encryption device.

The information encryption method of the present invention encrypts the distributed information with respect to devices other than a predesignated information processor, said information being distributed from an external information source; and comprises steps of:

defining, as an encryption key, unique information that is not duplicated in devices other than the predesignated information processor;

defining, as a decoding key, unique information that corresponds to the encryption key;

when encrypting distributed information, encrypting the distributed information with the unique information that is not duplicated as the encryption key; and

when decoding encrypted data, decoding the encrypted data with unique information that corresponds to the encryption key as the decoding key.

The above and other objects, features, and advantages of the present invention will become apparent from the following description referring to the accompanying drawings which illustrate examples of preferred embodiments of the present invention.

### BRIEF DESCRIPTION OF THE DRAWINGS

FIG. 1 is a block diagram showing the configuration of the first embodiment of the present invention.

FIG. 2 is a flow chart showing the progression of operations of the encryption process in the present invention.

FIG. 3 is a flow chart showing the progression of operations in the decoding process in the present invention.

FIG. 4 is a block diagram showing the configuration of the second embodiment of the present invention.

FIG. 5 is a block diagram showing the configuration of the third embodiment of the present invention.

FIG. 6 is a block diagram showing the configuration of the fourth embodiment of the present invention.

FIG. 7 is a block diagram showing the configuration of the fifth embodiment of the present invention.

### DETAILED DESCRIPTION OF THE PREFERRED EMBODIMENTS

Referring now to the figures, the information encryption device and method of the present invention are next explained in detail.

The present invention is constituted such that, when copying externally supplied information to an information storage medium that is provided in an information processor such as a personal computer, the range of use of the copied information is restricted to the information processor that performed the copying process.

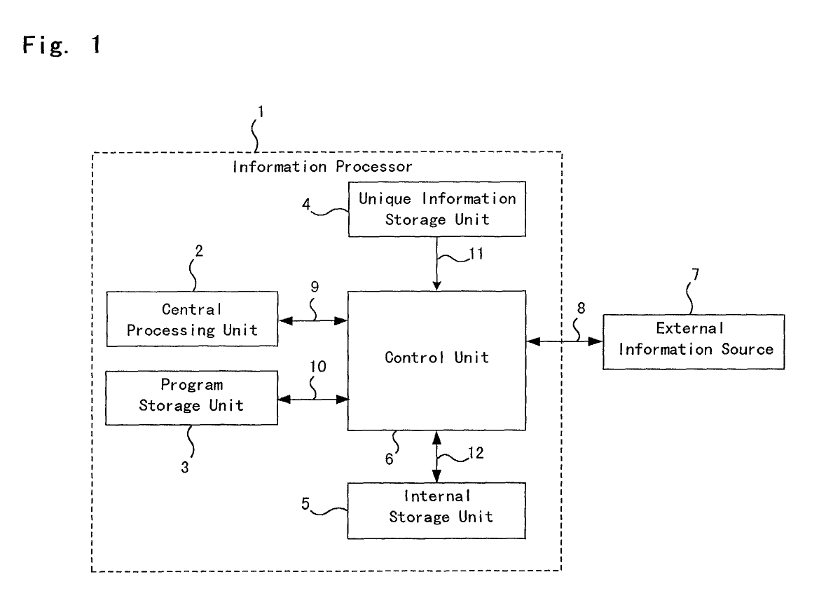

FIG. 1 shows an embodiment of the information encryption device for performing the information encryption method of the present invention.

Information processor 1, for example, a personal computer, holds unique information that specifies exclusively the information processor 1 of interest, or that is not duplicated in devices other than a predesignated information processor; encrypts information that is received from external information source 7 using this unique information as an encryption key; and stores the encrypted information in internal storage medium 5. The use of this encrypted information is thus restricted to only information processor 1 that performed the encryption. This detailed description, moreover, is premised on the assumption that, when referring to the internal storage medium, the information processor is provided with a drive mechanism for accessing the internal storage medium.

When the information stored in internal storage medium 5 is to be used, unique information that is specific to information processor 1 of interest is read in advance from unique information storage unit 4, and this read unique information is used as a decoding key for decoding.

With this configuration, information thus encrypted and stored in internal storage medium 5 can be used exclusively by information processor 1 that encrypted the information. This is because the decoding key that has to be used for decoding cannot be discriminated by information processors other than the information processor of interest (the processor that performed the encryption). The encryption key and decoding key can be made identical. The decoding key and encryption key can also be different if the decoding key is a key that corresponds to the encryption key (a key that the information processor can recognize as the key that decodes the encryption key).

Details of the first embodiment of the present invention are next described with reference to the figures.

Referring now to FIG. 1, the information encryption device of the present embodiment is constituted by information processor 1 such as a personal computer that is connected to external information source 7.

External information source 7 can be any device that supplies information to information processor 1 and need not be restricted to a specific device. For example, external information source 7 may be another information processor that is connected by way of a network, or may be a device capable of supplying information that is stored in a storage medium such as an AV (Audio Visual) device. Accordingly, a case is first described in the present embodiment in which external information source 7 is an AV device such as a CD driver or DVD driver, and a case is described in another embodiment in which external information source 7 is connected by way of a network.

Information processor 1 is provided with: central processing unit 2, program storage unit 3, unique information storage unit 4, internal storage medium 5, and control unit 6.

Central processing unit 2 executes various software programs. Program storage unit 3 temporarily stores a software program and the data that are generated by the software program. Unique information storage unit 4 holds unique information for discriminating information processor 1. Internal storage medium 5 is a nonvolatile storage medium. Control unit 6 is electrically connected to each of these constituent elements, executes control commands, and moreover, controls transmission of information.

The unique information is made up by a prescribed number of bits and can be constituted by the same form as an encryption/decoding key of the prior art.

Although internal storage medium 5 is typically constituted by a large-capacity storage medium such as a large-capacity hard disk, the present invention is not limited to a hard disk. For example, the present invention can also be applied to an interchangeable storage medium such as a writable CD-R or DVD.

In the present embodiment, explanation is given for a case in which internal storage medium 5 is a storage medium that cannot be interchanged, such as a hard disk; and explanation will be presented in another embodiment for a case in which internal storage medium 5 is an interchangeable or removable storage medium such as a CD-R or DVD.

In the first embodiment, a non-interchangeable storage medium such as a hard disk is used as internal storage medium 5 as described hereinabove, and software that describes the procedures for encryption and decoding and also the encrypted information are stored in this internal storage medium 5.

In FIG. 1, internal storage medium 5 is shown as constituted by a single unit, but this internal storage medium 5 in some cases is a plurality of internal storage areas set by dividing the storage area of one storage medium into a plurality of partitions or is provided with a plurality of actual internal storage media. The present invention can be realized in either case. Accordingly, internal storage medium 5 in FIG. 1 represents an internal storage medium of one or more units.

The storage of the above-described software that describes procedures need not be limited to internal storage medium 5 in FIG. 1. As long as sequential reading is possible when executing the software, any storage medium may be used to store the software.

Unique information storage unit 4 is constituted by a read-only storage medium such as ROM. Information that specifies the information processor of interest is stored in this unique information storage medium 4 at a stage such as the time of shipping the product.

Central processing unit 2 is constituted by a CPU (Central Processing Unit) and executes encryption and decoding processes in accordance with software that describes the above-described procedures.

Program storage unit 3 is constituted by a storage medium capable of high-speed access such as RAM (Random Access Memory), and temporarily stores software programs and various data.

Control unit 6 is connected to each of internal storage medium 5, unique information storage unit 4, central processing unit 2 and program storage unit 3 by way of corresponding interfaces and controls the transfer of information between each constituent element. Control unit 6 further controls access to external information source 7.

External information source 7 is a supply source of information distributed by, for example, a CD or DVD. The source is normally referred to as an AV device.

Central processing unit 2 and control unit 6 are connected through CPU bus 9, and control commands are issued to each unit from control unit 6 in accordance with the instructions of central processing unit 2. Program storage unit 3 and control unit 6 are connected through memory bus 10, and the reading and writing of data, stored in program storage unit 3, are executed in accordance with commands issued from control unit 6. Unique information storage unit 4 and control unit 6 are connected through system bus 11, and a red control to read the unique information, stored in unique information storage unit 4, is performed as necessary by control unit 6. Internal storage medium 5 and control unit 6 are connected through HD bus 12, and read control from and write control to internal storage medium 5 are effected under the control of control unit 6.

External information source 7 and control unit 6 are connected through external media bus 8, and the read control from and write control to external information source 7 is effected by control unit 6.

The operation of the present embodiment can be roughly divided into operations to encrypt information received from external information source 7 and operations to decode this encrypted information.

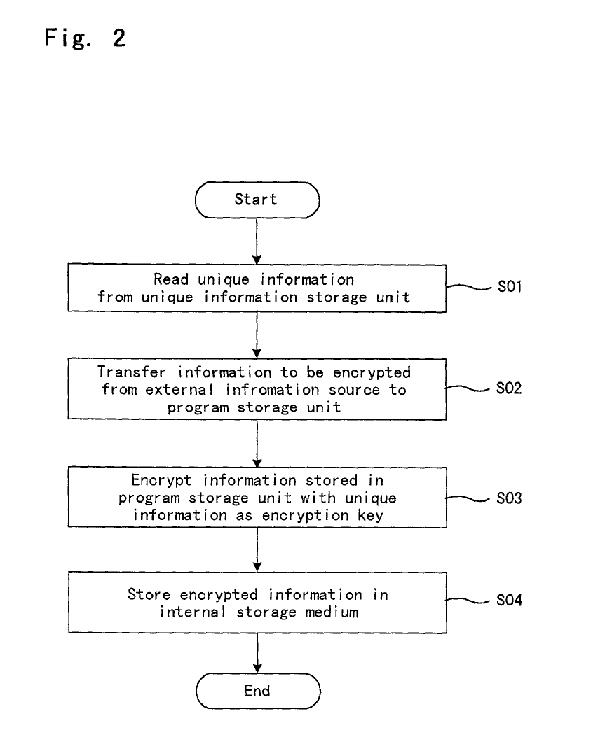

FIG. 2 is a flow chart showing the flow of processing for performing the encryption process of the present embodiment.

As shown in FIG. 2, at the initial time when the encryption process begins, the information encryption program according to the present invention first reads the stored unique information from unique information storage unit 4 (Step S01). This read unique information is held in central processing unit 2 as the encryption key.

Next, the information that is the object of encryption (such as voice information or image information, hereinafter referred to an object information) is read from external information source 7 and temporarily held in program storage unit 3 (Step S02). This process is executed under the control of control unit 6 in accordance with instructions from central processing unit 2.

Next, central processing unit 2 reads the object information stored in program storage unit 3, encrypts by prescribed amounts of the object information using the read unique information as the encryption key, and sequentially writes this encrypted information to program storage unit 3 (Step S03). Although many techniques have been proposed regarding the encryption method, the encryption method is not particularly restricted in the present invention, and any method can be used as long as unique information can be used as the encryption key. Encrypted information that is stored in program storage unit 3 is next written to internal storage medium 5 (Step S04). For this process, there are: a method in which central processing unit 2 executes a process in which encrypted information is read from program storage unit 3 and written to internal storage medium 5; and a method in which central processing unit 2 gives instructions to control unit 6, and based on these instructions, control unit 6 transmits information from program storage unit 3 to internal storage medium 5.

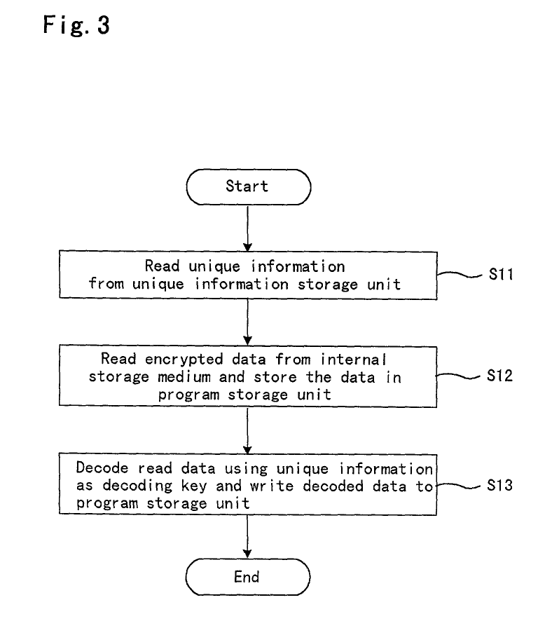

FIG. 3 is a flow chart showing the progression of the decoding process for decoding information that has been encrypted by the above-described process.

AS shown in FIG. 3, when the decoding process begins, unique information is read from unique information storage unit 4 and held inside central processing unit 2 as a decoding key, similar to the encryption process (Step S11).

Central processing unit 2 then reads the encrypted data from internal storage medium 5 and stores the data in program storage unit 3 (Step S12).

Central processing unit 2 next reads the encrypted information from program storage unit 3 (the encrypted information has been stored in program storage unit 3 in Step S12), sequentially decodes this encrypted information in prescribed blocks of information using the decoding key (central processing unit 2 reads decoding key from unique information storage unit 4 in Step S11 and holds the decoding key), and writes the decoded information to program storage unit 3 (Step S13).

The decoding is performed using a method that corresponds to the above-described encryption method, de-shuffling being used if the method used in encryption is shuffling, and de-scrambling if the method used in encryption is scrambling. This approach is based on the concept that encryption and decoding are executed by the same software.

Since the decoding key that is used in the decoding process must be the same as, or must correspond to the encryption key that was used in the encryption process as described in the foregoing explanation, information processors that are capable of decoding are inevitably limited to the information processor that performed the encryption.

The information that is obtained after decoding is thus displayed as an image if image data, reproduced as voice if voice data, and displayed as a document if document data. The process for reproducing this type of decoded information is not affected by the encryption and decoding of the present invention, and the reproduction of decoded information can be realized by any method.

Information encrypted and stored in internal storage medium 5 can be copied to another storage medium such as a floppy disk or CD-R, but information that is copied in this way can be used only by an information processor that is provided with the decoding key. The possibility of using the information is therefore restricted to exclusively the information processor that encrypted the information.

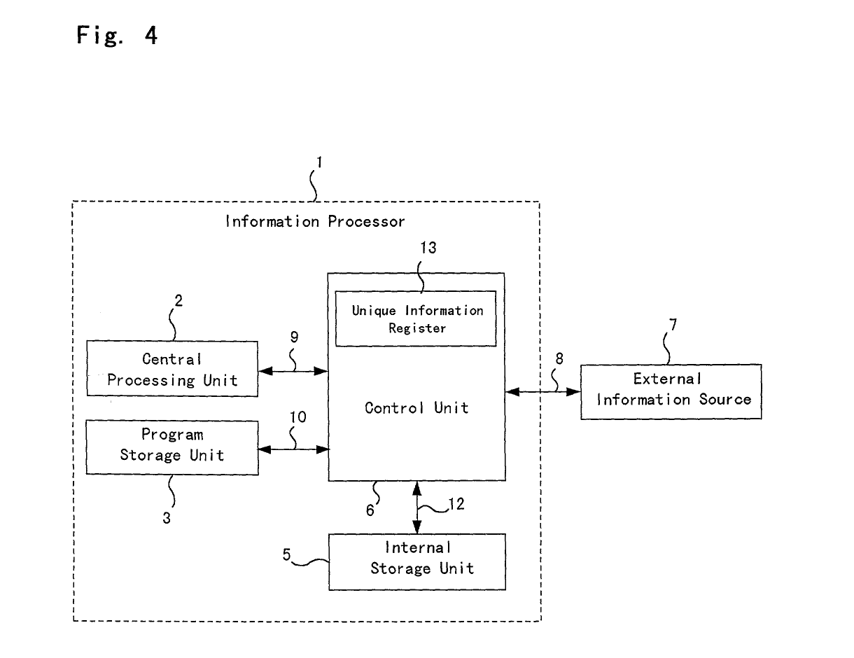

Next, regarding the second embodiment of the present invention, we refer to FIG. 4, which is a block diagram showing the configuration of the information encryption device of the second embodiment.

Referring to FIG. 4, the second embodiment is similar to the first embodiment in that it is provided with central processing unit 2, program storage unit 3, and internal storage medium 5 in information processor 1, but differs from the first embodiment in that it is provided with a data holding function (typically called a “register”) within control unit 6 in place of unique information storage unit 4 in the first embodiment.

In other words, control unit 6 of this embodiment is provided inside with unique information register 13 as the data holding function which information can be read from and written to. As unique information register 13, a register such as a one-time ROM is used in which information that has been written once cannot be rewritten. This type of register is used because the rewriting of stored unique information cannot be allowed.

The use of this type of non-rewritable storage medium as unique information register 13, and moreover, the storage of data that differ for each individual processor (for example, the serial number) in the above-described unique information register 13 during fabrication of information processor 1 enable the establishment of unique information inside information processor 1 which cannot be rewritten and also which is unique to the information processor of interest.

External information source 7 is the same as described in the first embodiment.

The typical use of ROM as unique information storage unit 4 in the first embodiment allows the easy removal of the unit from information processor 1 for copying or exchange. The second embodiment, however, makes the exchange of control unit 6 more difficult than in the first embodiment, and this embodiment can further be constituted to preclude the possibility of reading and copying the unique information.

The second embodiment can operate by the same progression of processes as in the operation of first embodiment.

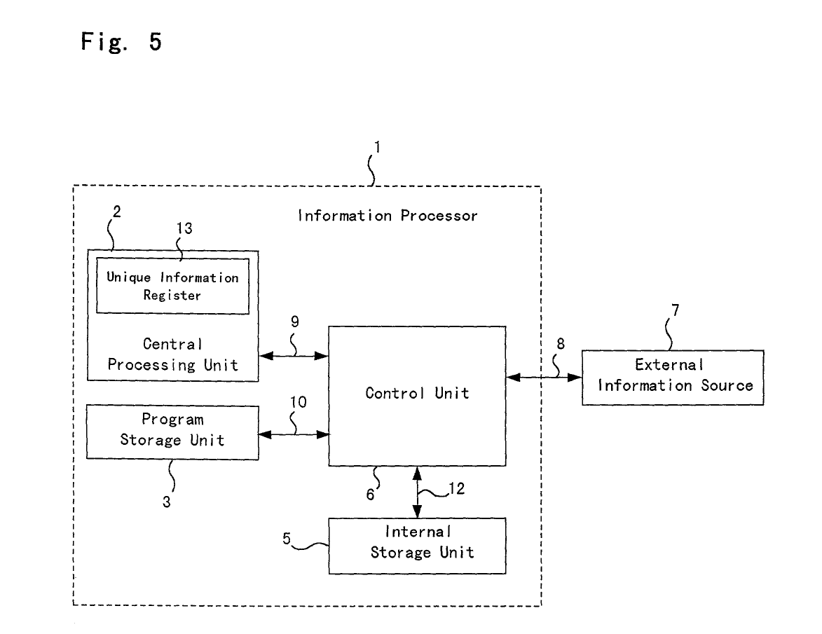

Next, regarding the third embodiment of the present invention, we refer to FIG. 5, which is a block diagram showing the configuration of the third embodiment of an information encryption device of the present invention.

Referring to FIG. 5, the third embodiment is similar to the first embodiment in that it is provided with program storage unit 3, internal storage medium 5 and control unit 6 in information processor 1, but differs from the first embodiment in that it is provided with unique information register 13 of the second embodiment in central processing unit 2.

In recent years, central processing unit 6 (CPU) is constituted such that a serial number is stored inside, and this serial number is therefore used in the present embodiment as the unique information.

The constitution of this embodiment eliminates the need to provide a special storage medium as a means for storing unique information as was shown in the first embodiment and can therefore realize a reduction in the scale of the device.

In this embodiment as well, external information source 7 is the same as described regarding the first embodiment.

The operation of the third embodiment can also be effected by the same process flow as the operation in the first embodiment and second embodiment.

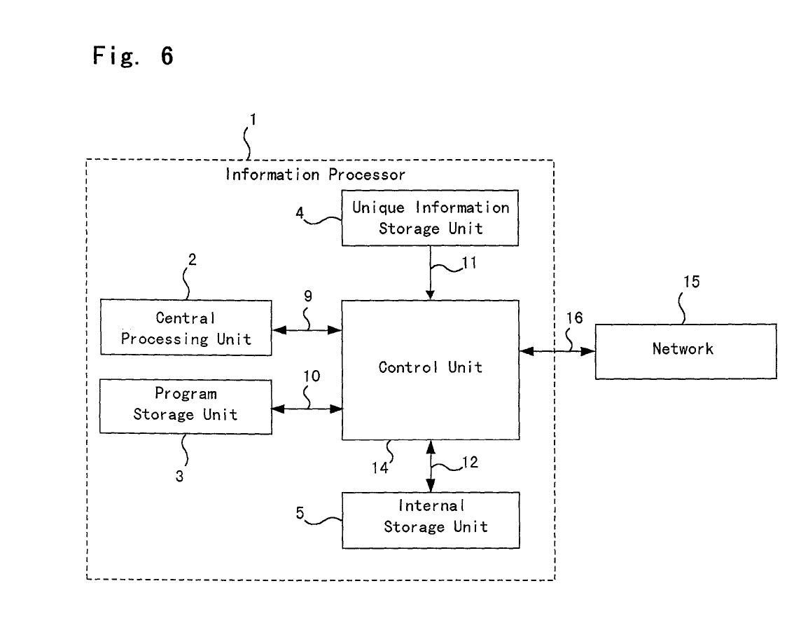

Next, regarding the fourth embodiment of the present invention, we refer to FIG. 6 in which is shown a block diagram of the configuration of the fourth embodiment of the information encryption device of the present invention.

In the fourth embodiment, information processor 1 is connected to a network, and the external information source is a terminal in this network.

Referring to FIG. 6, the fourth embodiment is similar to the first embodiment in that it is provided with central processing unit 2, program storage unit 3, unique information storage unit 4, and internal storage medium 5 in information processor 1; but differs from the first embodiment in that control unit 14 is constituted so as to include a network interface function in addition to the functions of control unit 6 in the first embodiment.

Control unit 14 can therefore be connected to network 15 by way of network circuit 16.

It can be assumed that network 15, which is connected via control unit 14, is in turn connected to a multiplicity of network terminals, but no limitations need be set regarding these terminals, any device being usable as a terminal as long as it functions as an external information source.

The above-described configuration of the fourth embodiment enables a terminal that is connected via the network to function as an external information source.

The operation of the fourth embodiment can be realized by the same process flow as the operation of the first to third embodiments.

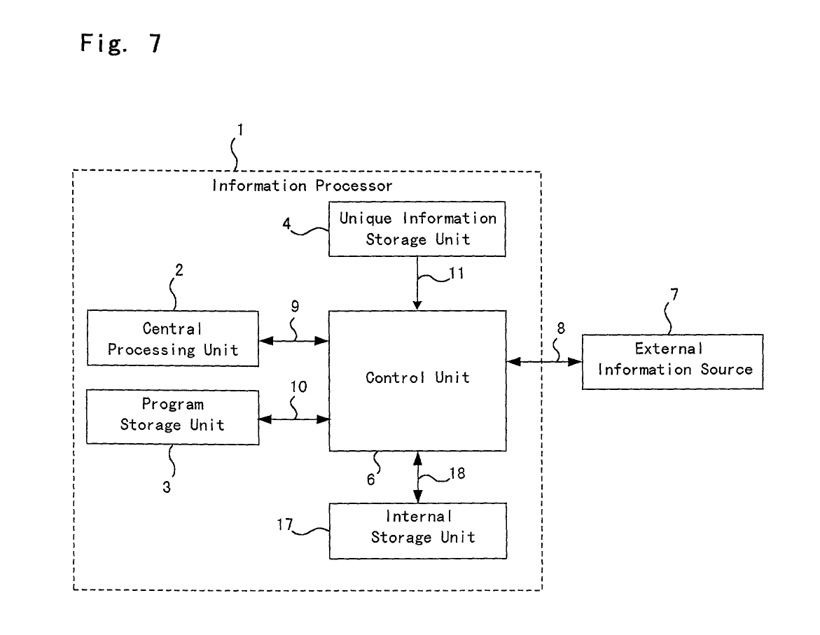

Next, regarding the fifth embodiment of the present invention, we refer to FIG. 7, which shows a block diagram of the fifth embodiment of the information encryption device of the present invention.

This embodiment is for a case in which an interchangeable or removable storage medium is used as the internal storage medium.

Referring now to FIG. 7, the fifth embodiment is similar to the first embodiment in that it is provided with central processing unit 2, program storage unit 3, and unique information storage unit 4 in information processor 1, but differs from the first embodiment in that it is provided with internal storage medium 17 that is constituted as the drive of an interchangeable or removable storage medium in place of internal storage medium 5.

Accordingly, control unit 6 and internal storage medium 17 are connected by internal storage medium bus 18.

In addition, the fifth embodiment may operate by the same process flow as the operation in the first to fourth embodiments.

Furthermore, each of the above-described embodiments may be worked by combining the configurations of each of the embodiment.

As described in the foregoing explanation, the information encryption device and encryption method of the present invention can preclude the possibility of copyright violations of copied information when copyrighted information such as image information or voice information is copied, by restricting the range of use of the copied information to the information processor that performed the copying.

It is to be understood, however, that although the characteristics and advantages of the present invention have been set forth in the foregoing description, the disclosure is illustrative only, and changes may be made in the shape, size, and arrangement of the parts within the scope of the appended claims.

What is claimed is:

1. An information encryption device that receives information distributed from an external information source, encrypts the information, stores the encrypted information, and, when using the information, decrypts the encrypted information, said information encryption device including an information processor, comprising:
a unique information storage means for storing a first unique information item that specifies exclusively a predesignated information encryption device and a second unique information item that corresponds to said first unique information item;
an encryption means for encrypting said distributed information that has been received with said first unique information item as an encryption key; and
a decoding means for decoding the information that has been encrypted by said encryption means with a second unique information item as a decoding key.

2. An information encryption device according to claim 1 wherein said unique information storage means is a read-only storage medium that permits only reading of said unique information items that have been stored.

3. An information encryption device according to claim 1 wherein said encryption key and said decoding key are identical.

4. An information encryption device according to claim 1, further comprising a data storage means for storing information that has been encrypted by said encryption means

5. An information encryption device according to claim 4 wherein said data storage means is constituted such that the storage medium into which encrypted information is written is inexchangeably fixed in the information processor.

6. An information encryption device according to claim 4 wherein said storage means is constituted such that a storage medium into which encrypted data are written is interchangeably installed in the information processor.

7. An information encryption device according to claim 1, further comprising a network interface means for taking in said distributed information.

8. An information encryption device according to claim 1 wherein said first unique information item includes unique information item that is stored before said information processor reaches a user.

9. An information encryption device according to claim 1 wherein said unique information storage means is provided with a register.

10. An information encryption device according to claim 8 wherein said first unique information item is a serial number that is assigned to that information processor.

11. An information encryption method that encrypts, to devices other than a predesignated information processor, distributed information that is distributed from an external information source for the purpose of using said information, comprising the steps of:
defining, as an encryption key, a first unique information item that is not duplicated in devices other than said predesignated information processor;
defining, as a decoding key, a second unique information item that corresponds to said encryption key;
when encrypting said distributed information, encrypting said distributed information with said first unique information item as the encryption key; and
when decoding said encrypted data, decoding said encrypted information with said second unique information as the decoding key.
